(19) United States
(12) Patent Application Publication
(10) Pub. No.: US 2019/0157682 A1
(43) Pub. Date: May 23, 2019

(54) ANODE SLURRY FOR SECONDARY BATTERY

(71) Applicant: GRST International Limited, Hong Kong (HK)

(72) Inventors: Kam Piu Ho, Hong Kong (HK); Ranshi Wang, Hong Kong (HK); Peihua Shen, Guangzhou, Guangdong (CN); Yingkai Jiang, Hong Kong (HK)

(73) Assignee: GRST International Limited, Hong Kong (HK)

(21) Appl. No.: 16/313,884

(22) PCT Filed: Nov. 17, 2017
(86) PCT No.: PCT/CN2017/111632

§ 371 Date: Dec. 27, 2018

Related U.S. Application Data
(60) Provisional application No. 62/425,619, filed on Nov. 23, 2016.

(51) Int. Cl. H01M 4/62; H01M 4/1391; H01M 4/36; H01M 4/38; H01M 10/0525; H01M 4/1393; H01M 4/1395

(52) U.S. Cl. CPC H01M 4/625; H01M 4/1391; H01M 4/364; H01M 4/1395; H01M 10/0525; H01M 4/1393; H01M 4/386

(57) ABSTRACT

Provided herein is an anode slurry for lithium-ion batteries, comprising a silicon-based material, a porous carbon aerogel, a binder material, a carbon active material, and a solvent, wherein the porous carbon aerogel has an average pore size from about 80 nm to about 500 nm. The porous carbon aerogel in the anode slurry disclosed herein provides sufficient space for expansion of the silicon-based material during intercalation of lithium ions. Cracking of the silicon-containing anode layer is prevented.

### FIELD OF THE INVENTION

The present invention relates to the field of batteries. In particular, this invention relates to anode slurries for lithium-ion batteries.

### BACKGROUND OF THE INVENTION

Lithium-ion batteries (LIBs) have attracted extensive attention in the past two decades for a wide range of applications in portable electronic devices such as cellular phones and laptop computers. Due to rapid market development of electric vehicles (EV) and grid energy storage, high-performance, low-cost LIBs are currently offering one of the most promising options for large-scale energy storage devices.

Characteristics of electrodes can dramatically affect performance and safety characteristics of battery. An anode of a conventional lithium-ion battery mainly includes a carbon-based anode material, such as mesocarbon microbeads and artificial graphite. The storage capacity of conventional lithium-ion batteries is limited since the full specific capacity of a carbon-based anode material has a theoretical value of 372 mAh/g. Compared to the carbon-based anode material, a silicon-containing anode material has a high theoretical specific capacity of about 4,000 mAh/g.

However, silicon-based anodes suffer from poor cycle life. During charge and discharge of the lithium-ion battery, lithium ions undergo intercalation and de-intercalation on the silicon-containing anode material, which results in volumetric expansion and contraction of the silicon-containing anode material. The resulting stresses tend to cause cracking in the anode layer, which in turn causes the anode materials to fall away from the electrode and a decrease in the service life of the lithium-ion battery. The cracking problem becomes more severe when aggregates of silicon particles are present in the anode. Therefore, preparation of the anode slurries is an essential first step towards the production of good quality batteries.

CN Patent No. 103236520 B discloses a method of preparing a silicon oxide/carbon composite for an anode material of a lithium-ion battery. The method comprises mixing resorcinol and formaldehyde in deionized water to obtain solution A; dissolving silicone in ethanol to obtain solution B; adding a gel catalyst to solution A to obtain solution C; adding an acidic catalyst to solution B to obtain solution D; adding solution D to solution C to obtain a gel; aging the gel by adding ethanol to it; drying the aged gel to obtain a precursor; and heating the precursor at 800° C. to 1200° C. to obtain the nano-silicon oxide/carbon composite powder. However, the aging step is rather time consuming.

US Patent Application No. 20160043384 A1 discloses an anode layer and a preparation method thereof. The anode layer comprises an anode active material embedded in pores of a solid graphene foam to accommodate volume expansion and shrinkage of the particles of the anode active material during a battery charge-discharge cycle. The anode layer is prepared by dispersing the anode active material and graphene material in a liquid medium to form a graphene dispersion; dispensing and depositing the graphene dispersion onto a surface of a supporting substrate to form a wet layer of graphene/anode active material; removing the liquid medium from the wet layer to form a dried layer; and heat-treating the dried layer of the mixture material. However, the graphene foam having embraced particles of the anode active material is pre-formed by complicated steps to lodge the particles of the anode active material in the pores of the graphene foam. In addition, a high temperature is required in the heat-treating step for re-organization of sheets of the graphene material into larger graphite crystals or domains and the anode prepared by this method has a low electrical conductivity because of the lack of current collector.

KR Patent No. 101576276 B1 discloses an anode active material and a preparation method thereof. The anode active material comprises a silicon coating layer positioned on the surface of a reduced graphene oxide aerogel wherein the silicon coating layer comprises silicon particles having a particle size of 5 nm to 20 nm. The anode active material is prepared by dispersing graphene oxide sheets in an aqueous solution; freezing the aqueous solution; freeze-drying the frozen material to obtain a graphene oxide aerogel; reducing the graphene oxide aerogel; and coating silicon onto the surface of the reduced graphene oxide aerogel by chemical vapour deposition (CVD). However, the method is complicated and the CVD process requires expensive equipment and involves high manufacturing costs.

In view of the above, there is always a need to develop an anode slurry for improving the stability of the silicon anode.

### SUMMARY OF THE INVENTION

The aforementioned needs are met by various aspects and embodiments disclosed herein.

In one aspect, provided herein is an anode slurry, comprising a silicon-based material, a porous carbon aerogel, a binder material, a carbon active material, and a solvent, wherein the porous carbon aerogel has an average pore size from about 80 nm to about 500 nm.

In some embodiments, the silicon-based material is selected from the group consisting of Si, SiOₓ, Si/C, SiOₓ/C, Si/M, and combinations thereof, wherein each x is independently from 0 to 2; M is selected from an alkali metal, an alkaline-earth metal, a transition metal, a rare earth metal, or a combination thereof, and is not Si.

In certain embodiments, the silicon-based material has an average particle size from about 10 nm to about 500 nm. In some embodiments, the silicon-based material has an average particle size from about 30 nm to about 200 nm. In some embodiments, the silicon-based material is present in an amount from about 1% to about 10% by weight, based on the total weight of the anode slurry.

In some embodiments, the porous carbon aerogel is selected from the group consisting of a carbonized resorcinol-formaldehyde aerogel, a carbonized phenol-formaldehyde aerogel, a carbonized melamine-resorcinol-formaldehyde aerogel, a carbonized phenol-melamine-formaldehyde aerogel, a carbonized 5-methylresorcinol-formaldehyde aerogel, a carbonized phloroglucinol-phenol-formaldehyde aerogel, a graphene aerogel, a carbon nanotube aerogel, a nitrogen-doped carbonized resorcinol-formaldehyde aerogel, a nitrogen-doped graphene aerogel, a nitrogen-doped carbon nanotube aerogel, a sulphur-doped carbonized resorcinol-formaldehyde aerogel, a sulphur-doped graphene aerogel, a sulphur-doped carbon nanotube aerogel, a nitrogen and sulphur co-doped carbonized resorcinol-formaldehyde aerogel, and combinations thereof.

In certain embodiments, the porous carbon aerogel has an average particle size from about 100 nm to about 1 μm. In some embodiments, the porous carbon aerogel is present in an amount from about 0.1% to about 10% by weight, based on the total weight of the anode slurry.

In some embodiments, the weight ratio of the silicon-based material to the porous carbon aerogel is from about 1:1 to about 10:1. In certain embodiments, the weight ratio of the silicon-based material to the porous carbon aerogel is from about 5:1 to about 10:1.

In certain embodiments, the ratio of the pore size of the porous carbon aerogel to the particle size of the silicon-based material is from about 2:1 to about 20:1. In some embodiments, the ratio of the pore size of the porous carbon aerogel to the particle size of the silicon-based material is from about 2:1 to about 10:1.

In some embodiments, the porosity of the porous carbon aerogel is from about 50% to about 90%.

In certain embodiments, the specific surface area of the porous carbon aerogel is from about 100 m²/g to about 1,500 m²/g.

In some embodiments, the density of the porous carbon aerogel is from about 0.01 g/cm³ to about 0.9 g/cm³.

In certain embodiments, the electrical conductivity of the porous carbon aerogel is from about 1 S/cm to about 30 S/cm.

In some embodiments, the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose, hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid, polyacrylate, polymethacrylic acid, polymethacrylate, polyacrylamide, polyurethane, fluorinated polymer, chlorinated polymer, a salt of alginic acid, polyvinylidene fluoride, poly(vinylidene fluoride)-hexafluoropropene, and combinations thereof.

In certain embodiments, the carbon active material is selected from the group consisting of hard carbon, soft carbon, artificial graphite, natural graphite, mesocarbon microbeads, and combinations thereof. In some embodiments, the particle size of the carbon active material is from about 1 μm to about 20 μm.

In some embodiments, the solvent is selected from the group consisting of water, ethanol, isopropanol, methanol, acetone, n-propanol, t-butanol, N-methyl-2-pyrrolidone, and combinations thereof.

### BRIEF DESCRIPTION OF THE DRAWINGS

FIG. 1 depicts an embodiment of the method for preparing the anode slurry disclosed herein.

FIG. 2 depicts a schematic structure of a porous carbon aerogel comprising a silicon-based material residing inside its pores.

### DETAILED DESCRIPTION OF THE INVENTION

### General Definitions

The term “silicon-based material” refers to a material consisting of silicon or a combination of silicon and other elements.

The term “aerogel” refers to a highly porous material of low density, which is prepared by forming a gel and then removing solvent from the gel while substantially retaining the gel structure.

The term “gel” refers to a solid or semi-solid substance that is formed by the solidification of an aqueous colloidal dispersion and may exhibit an organized material structure.

The term “sol-gel process” refers to a process which comprises the formation of a colloidal suspension (sol) and gelation of the sol to form a network in a continuous liquid phase (gel).

The term “carbon aerogel” refers to a highly porous carbon-based material. Some non-limiting examples of the carbon aerogel include a carbonized aerogel such as a carbonized resorcinol-formaldehyde aerogel and a nitrogen-doped carbonized resorcinol-formaldehyde aerogel; a graphene aerogel; and a carbon nanotube aerogel.

The term “carbonized aerogel” refers to an organic aerogel which has been subjected to pyrolysis in order to decompose or transform the organic aerogel composition to at least substantially pure carbon.

The term “pyrolyze” or “pyrolysis” or “carbonization” refers to the decomposition or transformation of an organic compound or composition to pure or substantially pure carbon caused by heat.

The term “substantially pure” with respect to carbon is intended to refer to at least greater than 80% pure, at least greater than 85% pure, at least greater than 90% pure, at least greater than 95% pure or even greater than 99% pure carbon.

The term “carbon nanotube aerogel” refers to a highly porous, low density structure formed from carbon nanotubes.

The term “graphene aerogel” refers to an aerogel comprising graphene.

The term “dispersing” refers to an act of distributing a chemical species or a solid more or less evenly throughout a fluid.

The term “homogenizer” refers to an equipment that can be used for homogenization of materials. The term “homogenization” refers to a process of reducing a substance or material to small particles and distributing it uniformly throughout a fluid. Any conventional homogenizers can be used for the method disclosed herein. Some non-limiting examples of the homogenizer include stirring mixers, blenders, mills (e.g., colloid mills and sand mills), ultrasonicators, atomizers, rotor-stator homogenizers, and high pressure homogenizers.

The term “ultrasonicator” refers to an equipment that can apply ultrasonic energy to agitate particles in a sample. Any ultrasonicator that can disperse the slurry disclosed herein can be used herein. Some non-limiting examples of the ultrasonicator include an ultrasonic bath, a probe-type ultrasonicator, and an ultrasonic flow cell.

The term “ultrasonic bath” refers to an apparatus through which the ultrasonic energy is transmitted via the container's wall of the ultrasonic bath into the liquid sample.

The term “probe-type ultrasonicator” refers to an ultrasonic probe immersed into a medium for direct sonication. The term “direct sonication” means that the ultrasound is directly coupled into the processing liquid.

The term “ultrasonic flow cell” or “ultrasonic reactor chamber” refers to an apparatus through which sonication processes can be carried out in a flow-through mode. In some embodiments, the ultrasonic flow cell is in a single-pass, multiple-pass or recirculating configuration.

The term “planetary mixer” refers to an equipment that can be used to mix or stir different materials for producing a homogeneous mixture, which consists of blades conducting a planetary motion within a vessel. In some embodiments, the planetary mixer comprises at least one planetary blade and at least one high speed dispersion blade. The planetary and the high speed dispersion blades rotate on their own axes and also rotate continuously around the vessel. The rotation speed can be expressed in unit of rotations per minute (rpm) which refers to the number of rotations that a rotating body completes in one minute.

The term “dispersant” refers to a chemical that can be used to promote uniform and maximum separation of fine particles in a suspending medium and form a stable suspension.

The term “binder material” refers to a chemical or a substance that can be used to hold the active battery electrode material and conductive agent in place.

The term “carbon active material” refers to an active material having carbon as a main skeleton, into which lithium ions can be intercalated. Some non-limiting examples of the carbon active material include a carbonaceous material and a graphitic material. The carbonaceous material is a carbon material having a low degree of graphitization (low crystallinity). The graphitic material is a material having a high degree of crystallinity.

The term “applying” as used herein in general refers to an act of laying or spreading a substance on a surface.

The term “current collector” refers to a support for coating the active battery electrode material and a chemically inactive high electron conductor for keeping an electric current flowing to electrodes during discharging or charging a secondary battery.

The term “electrode” refers to a “cathode” or an “anode.”

The term “positive electrode” is used interchangeably with cathode. Likewise, the term “negative electrode” is used interchangeably with anode.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C.+/−1° C. or +/−2° C. or +/−3° C. In other embodiments, room temperature refers to a temperature of about 22° C. or about 25° C.

The term “solid content” refers to the amount of non-volatile material remaining after evaporation.

The term “C rate” refers to the charging or discharging rate of a cell or battery, expressed in terms of its total storage capacity in Ah or mAh. For example, a rate of 1 C means utilization of all of the stored energy in one hour; a 0.1 C means utilization of 10% of the energy in one hour or the full energy in 10 hours; and a 5 C means utilization of the full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 Ampere-hour (Ah) is the equivalent of 3,600 coulombs of electrical charge. Similarly, the term “miniampere-hour (mAh)” also refers to a unit of the storage capacity of a battery and is 1/1,000 of an ampere-hour.

The term “battery cycle life” refers to the number of complete charge/discharge cycles a battery can perform before its nominal capacity falls below 80% of its initial rated capacity.

The term “major component” of a composition refers to the component that is more than 50%, more than 55%, more than 60%, more than 65%, more than 70%, more than 75%, more than 80%, more than 85%, more than 90%, or more than 95% by weight or volume, based on the total weight or volume of the composition.

The term “minor component” of a composition refers to the component that is less than 50%, less than 45%, less than 40%, less than 35%, less than 30%, less than 25%, less than 20%, less than 15%, less than 10%, or less than 5% by weight or volume, based on the total weight or volume of the composition.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Provided herein is an anode slurry, comprising a silicon-based material, a porous carbon aerogel, a binder material, a carbon active material, and a solvent, wherein the porous carbon aerogel has an average pore size from about 80 nm to about 500 nm.

In another aspect, provided herein is a method of preparing an anode slurry, comprising the steps of:

1) dispersing a porous carbon aerogel in a solvent to form a first suspension;

2) dispersing a silicon-based material in the first suspension to form a second suspension;

3) homogenizing the second suspension by a homogenizer to form a homogenized second suspension;

4) dispersing a binder material in the homogenized second suspension to form a third suspension; and

5) dispersing a carbon active material in the third suspension to form the anode slurry;

wherein the porous carbon aerogel has an average pore size from about 80 nm to about 500 nm.

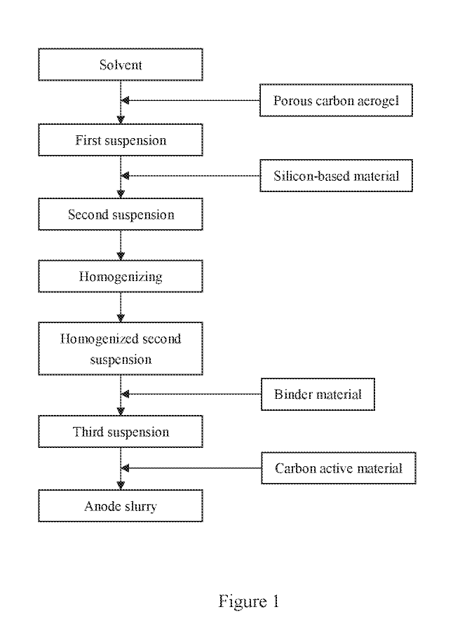

FIG. 1 shows an embodiment of the method for preparing anode slurry disclosed herein. A porous carbon aerogel is dispersed in a solvent to form a first suspension. A silicon-based material is then dispersed in the first suspension to obtain a second suspension. The second suspension is homogenized by a homogenizer to form a homogenized second suspension. A binder material is dispersed in the homogenized second suspension to form a third suspension. An anode slurry is prepared by dispersing a carbon active material in the third suspension.

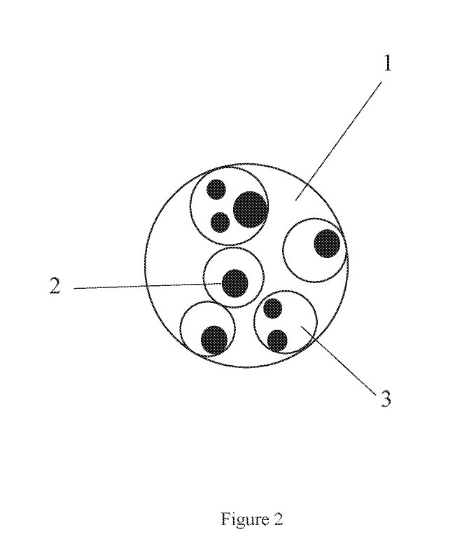

In some embodiments, the first suspension is prepared by dispersing a porous carbon aerogel in a solvent. The porous carbon aerogel allows the silicon-based material to diffuse into and reside in its pores. The pores provide sufficient space for the expansion of the silicon-based material during intercalation of lithium ions. Therefore, cracking of an anode layer prepared by the anode slurry disclosed herein can be avoided. FIG. 2 shows a schematic structure of a porous carbon aerogel (1) comprising a silicon-based material (2) residing inside the pores (3) of the porous carbon aerogel. These features make the porous carbon aerogel suitable for manufacturing lithium-ion batteries with silicon anodes. Some non-limiting examples of the porous carbon aerogel include a carbonized aerogel, a graphene aerogel, and a carbon nanotube aerogel. A carbonized aerogel can be prepared by methods well known in the art. Briefly, a gel is prepared, then the solvent is removed by any suitable method that substantially preserves the gel structure and pore size to form an organic aerogel. The method of solvent removal can be supercritical fluid extraction, evaporation of liquid, or freeze-drying. The organic aerogel can then be pyrolyzed to form the carbonized aerogel.

In certain embodiments, the organic aerogels may be synthesized by supercritical drying of the gels obtained by the sol-gel polycondensation reaction of monomers such as phenols with formaldehyde or furfural in aqueous solutions. Some non-limiting examples of phenols used to make organic aerogels include resorcinol, phenol, catechol, phloroglucinol, and other polyhydroxybenzene compounds that react in the appropriate ratio with formaldehyde or furfural. Suitable precursor combinations include, but are not limited to, resorcinol-furfural, resorcinol-formaldehyde, phenol-resorcinol-formaldehyde, catechol-formaldehyde, phloroglucinol-formaldehyde, and combinations thereof.

The porous carbon aerogel disclosed herein provides volume accommodations for expansion and contraction of the silicon-based material. In some embodiments, the porous carbon aerogel is selected from the group consisting of a carbonized resorcinol-formaldehyde aerogel, a carbonized phenol-formaldehyde aerogel, a carbonized melamine-resorcinol-formaldehyde aerogel, a carbonized phenol-melamine-formaldehyde aerogel, a carbonized 5-methylresorcinol-formaldehyde aerogel, a carbonized phloroglucinol-phenol-formaldehyde aerogel, a graphene aerogel, a carbon nanotube aerogel, and combinations thereof. Different pore sizes of the porous carbon aerogel can be obtained by varying the precursor combinations.

In certain embodiments, the porous carbon aerogel may be doped or impregnated with selected materials to increase the electrical conductivity thereof. In some embodiments, the doped porous carbon aerogel is a doped carbonized aerogel, a doped graphene aerogel, or a doped carbon nanotube aerogel. In certain embodiments, the dopant is selected from the group consisting of boron, nitrogen, sulfur, phosphorus, and combinations thereof. Some non-limiting example of the doped porous carbon aerogel include a nitrogen-doped carbonized resorcinol-formaldehyde aerogel, a nitrogen-doped graphene aerogel, a nitrogen-doped carbon nanotube aerogel, a sulphur-doped carbonized resorcinol-formaldehyde aerogel, a sulphur-doped graphene aerogel, a sulphur-doped carbon nanotube aerogel, and a nitrogen and sulphur co-doped carbonized resorcinol-formaldehyde aerogel. In some embodiments, the amount of the dopant is from about 0.5% to about 5%, from about 0.5% to about 3%, from about 1% to about 5%, or from about 1% to about 3% by weight, based on the total weight of the doped porous carbon aerogel. In certain embodiments, the amount of the dopant is less than 5%, less than 4%, less than 3%, less than 2%, or less than 1% by weight, based on the total weight of the doped porous carbon aerogel.

In some embodiments, the particle size of the porous carbon aerogel is from about 100 nm to about 1 μm, from about 100 nm to about 800 nm, from about 100 nm to about 600 nm, from about 100 nm to about 500 nm, from about 300 nm to about 1 μm, or from about 500 nm to about 1 μm.

The pores of the porous carbon aerogel provide space for expansion of the silicon-based material during insertion of the lithium ions during the battery operation. If the pore size of the porous carbon aerogel is too small, the silicon-based material cannot diffuse therein. When the pore size of the porous carbon aerogel is larger than 500 nm, agglomeration of silicon-based material in the pore of the porous carbon aerogel occurs.

In certain embodiments, the porous carbon aerogel has a unimodal pore structure. In some embodiments, the average pore size of the porous carbon aerogel is from about 80 nm to about 500 nm, from about 80 nm to about 400 nm, from about 80 nm to about 300 nm, from about 80 nm to about 200 nm, from about 80 nm to about 150 nm, from about 100 nm to about 350 nm, from about 100 nm to about 300 nm, or from about 100 nm to about 200 nm. In certain embodiments, the average pore size of the porous carbon aerogel is less than 500 nm, less than 400 nm, less than 300 nm, less than 200 nm, less than 150 nm, or less than 100 nm. In some embodiments, the pore size of the porous carbon aerogel is greater than 400 nm, greater than 300 nm, greater than 200 nm, or greater than 100 nm.

The porous carbon aerogel can be characterized by its relatively high porosity, relatively high surface area and relatively low density. In some embodiments, the porous carbon aerogel used in the present invention has a porosity of at least 40%, at least 50%, at least 60%, at least 70%, at least 80%, or at least 90%. In certain embodiments, the porosity of the porous carbon aerogel is from about 40% to about 90%, from about 50% to about 90%, from about 60% to about 90%, from about 50% to about 80%, or from about 60% to about 80%. There will be sufficient free space to accommodate a high silicon content and allow volumetric expansion of silicon-based material during lithiation when the porous carbon aerogel has a high porosity.

In some embodiments, the specific surface area of the porous carbon aerogel is from about 50 m²/g to about 2,000 m²/g, from about 100 m²/g to about 1,500 m²/g, from about 100 m²/g to about 1,000 m²/g, from about 500 m²/g to about 1,500 m²/g, from about 500 m²/g to about 1,000 m²/g, or from about 1,000 m²/g to about 1,500 m²/g.

The density of the porous carbon aerogel must be low and uniform in order to be balanced with the suspension medium to prevent sedimentation of the porous carbon aerogel. In some embodiments, the density of the porous carbon aerogel is from about 0.01 g/cm³ to about 0.9 g/cm³, from about 0.05 g/cm³ to about 0.5 g/cm³, from about 0.05 g/cm³ to about 0.3 g/cm³, from about 0.1 g/cm³ to about 0.5 g/cm³, from about 0.1 g/cm³ to about 0.3 g/cm³, from about 0.3 g/cm³ to about 0.9 g/cm³, or from about 0.3 g/cm³ to about 0.5 g/cm³. In certain embodiments, the density of the porous carbon aerogel is less than 0.9 g/cm³, less than 0.5 g/cm³, less than 0.4 g/cm³, less than 0.3 g/cm³, less than 0.1 g/cm³, less than 0.05 g/cm³, or less than 0.01 g/cm³.

The porous carbon aerogel is electrically-conductive which can enhance electrical conductivity of the anode during battery operation. In certain embodiments, the electrical conductivity of the porous carbon aerogel is from about 1 S/cm to about 35 S/cm, from about 1 S/cm to about 30 S/cm, from about 1 S/cm to about 20 S/cm, or from about 1 S/cm to about 10 S/cm.

In certain embodiments, the amount of the porous carbon aerogel in the first suspension is from about 0.1% to about 10%, from about 0.1% to about 5%, from about 0.1% to about 4%, from about 0.1% to about 3%, from about 0.1% to about 2%, from about 0.1% to about 1%, from about 0.5% to about 3%, from about 0.5% to about 2%, or from about 0.5% to about 1.5% by weight, based on the total weight of the first suspension. In some embodiments, the amount of the porous carbon aerogel in the first suspension is less than 5%, less than 4%, less than 3%, less than 2%, less than 1.5%, or less than 1% by weight, based on the total weight of the first suspension. In certain embodiments, the amount of the porous carbon aerogel in the first suspension is at least 0.1%, at least 0.5%, at least 0.8%, or at least 1% by weight, based on the total weight of the first suspension.

In some embodiments, part of the silicon-based material is present in the form of agglomerates. When the porous carbon aerogel has a unimodal pore structure, the agglomerates of the silicon-based material having a size larger than the pore of the porous carbon aerogel cannot diffuse into the pores of the porous carbon aerogel. Therefore, the anode active layer may crack due to volume change of the silicon-based material after repeated charge/discharge cycles.

In certain embodiments, the pore size distribution of the porous carbon aerogel displays at least two peaks of pore diameters, each peak having a maximum. In some embodiments, the porous carbon aerogel has a bimodal pore structure with both smaller and larger pores. In this case, the agglomerates of the silicon-based material can also be accommodated by the larger pores. In other embodiments, the porous carbon aerogel comprises a major proportion of small pores and a minor proportion of large pores effective in retaining the agglomerates of the silicon-based material.

In some embodiments, the porous carbon aerogel having pores exhibiting a bimodal size distribution with two pore diameter peaks, wherein the pores have a first peak in a range of the pore size (i.e., the smaller pores) from about 80 nm to about 250 nm and a second peak in a range of the pore size (i.e., the larger pores) from about 250 nm to about 500 nm.

In certain embodiments, the first peak has a pore size from about 80 nm to about 250 nm, from about 80 nm to about 200 nm, from about 80 nm to about 180 nm, from about 80 nm to about 160 nm, from about 80 nm to about 140 nm, or from about 80 nm to about 120 nm. In some embodiments, the first peak has a pore size less than 250 nm, less than 200 nm, less than 180 nm, less than 160 nm, less than 140 nm, less than 120 nm, or less than 100 nm.

In some embodiments, the second peak has a pore size from about 200 nm to about 500 nm, from about 200 nm to about 400 nm, from about 200 nm to about 350 nm, from about 200 nm to about 300 nm, from about 200 nm to about 250 nm, from about 300 nm to about 500 nm, or from about 300 nm to about 400 nm. In certain embodiments, the second peak has a pore size greater than about 400 nm, greater than about 350 nm, greater than about 300 nm, greater than about 250 nm, or greater than about 200 nm.

In certain embodiments, the relative intensity of the first peak is greater than the second peak. In some embodiments, the height ratio of the first peak to the second peak is from about 2:1 to about 10:1, from about 4:1 to about 10:1, from about 6:1 to about 10:1, or from about 8:1 to about 10:1.

In some embodiments, instead of having a bimodal structure, the anode slurry comprises a mixture of porous carbon aerogels with different pore sizes. In certain embodiments, the porous carbon aerogel comprises a first porous carbon aerogel having an average pore size from about 80 nm to about 250 nm and a second porous carbon aerogel having an average pore size from about 250 nm to about 500 nm. In some embodiments, the first porous carbon aerogel has an average pore size from about 80 nm to about 250 nm, from about 80 nm to about 200 nm, from about 80 nm to about 180 nm, from about 80 nm to about 160 nm, from about 80 nm to about 140 nm, or from about 80 nm to about 120 nm. In certain embodiments, the first porous carbon aerogel has an average pore size less than 250 nm, less than 200 nm, less than 180 nm, less than 160 nm, less than 140 nm, less than 120 nm, or less than 100 nm. In certain embodiments, the second porous carbon aerogel has an average pore size from about 200 nm to about 500 nm, from about 200 nm to about 400 nm, from about 200 nm to about 350 nm, from about 200 nm to about 300 nm, from about 200 nm to about 250 nm, from about 300 nm to about 500 nm, or from about 300 nm to about 400 nm. In some embodiments, the second porous carbon aerogel has an average pore size greater than about 400 nm, greater than about 350 nm, greater than about 300 nm, greater than about 250 nm, or greater than about 200 nm.

In certain embodiments, the weight ratio of the first porous carbon aerogel to the second porous carbon aerogel in the anode slurry is from about 10:1 to about 1:10, from about 10:1 to about 1:5, from about 10:1 to about 1:1, from about 10:1 to about 2:1, from about 10:1 to about 4:1, from about 10:1 to about 6:1, or from about 10:1 to about 8:1. In some embodiments, the weight ratio of the first porous carbon aerogel to the second porous carbon aerogel in the anode slurry is about 10:1, about 8:1, about 6:1, about 4:1, about 2:1, about 1:1, about 1:5, or about 1:10.

In some embodiments, the amount of each of the first porous carbon aerogel and the second porous carbon aerogel in the first suspension is independently from about 0.1% to about 10%, from about 0.1% to about 5%, from about 0.1% to about 4%, from about 0.1% to about 3%, from about 0.1% to about 2%, or from about 0.1% to about 1% by weight, based on the total weight of the first suspension.

In certain embodiments, the first suspension has a solid content from about 0.1% to about 10%, from about 0.1% to about 5%, from about 0.1% to about 3%, or from about 0.1% to about 1% by weight, based on the total weight of the first suspension. In certain embodiments, the first suspension has a solid content of at least 0.1%, at least 0.3%, at least 0.5%, at least 0.7%, at least 0.9%, or at least 1% by weight, based on the total weight of the first suspension.

In some embodiments, the first suspension is homogenized by a homogenizer for a time period from about 0.5 hour to about 3 hours. In certain embodiments, the homogenizer is a planetary mixer. In further embodiments, the first suspension is homogenized for a time period from about 0.5 hour to about 2 hours, from about 0.5 hour to about 1 hour, from about 1 hour to about 3 hours, or from about 1 hour to about 2 hours.

Silicon-based anodes are employed to replace the low capacity graphite anode in order to increase both the specific and volumetric energies of lithium-ion batteries because silicon has high lithium storage capacity. In certain embodiments, a second suspension is prepared by dispersing a silicon-based material in the first suspension. In some embodiments, the silicon-based material is selected from the group consisting of Si, SiOₓ, Si/C, SiOₓ/C, Si/M, and combinations thereof, wherein each x is independently from 0 to 2; M is selected from an alkali metal, an alkaline-earth metal, a transition metal, a rare earth metal, or a combination thereof, and is not Si.

In certain embodiments, the silicon-based material has a substantially spherical shape. Some non-limiting examples of the substantially spherical shape include spherical, spheroidal and the like. In other embodiments, the silicon-based material has a substantially non-spherical shape. Some non-limiting examples of the substantially non-spherical shape include irregular shape, square, rectangular, needle, wire, tube, rod, sheet, ribbon, flake, and the like. In certain embodiments, the shape of the silicon-based material is not wire, tube, rod, sheet, or ribbon. When the silicon-based material has an elongated shape, the pore space in the porous carbon aerogel may be insufficient to accommodate the volume expansion of the silicon-based material.

When the particle size of the silicon-based material is too large (e.g., larger than 500 nm), the silicon-based material will undergo a very large volume expansion, thereby causing cracking of anode coating layer. In some embodiments, the particle size of the silicon-based material is from about 10 nm to about 500 nm, from about 10 nm to about 400 nm, from about 10 nm to about 300 nm, from about 10 nm to about 200 nm, from about 10 nm to about 150 nm, from about 10 nm to about 100 nm, from about 10 nm to about 50 nm, from about 30 nm to about 200 nm, from about 30 nm to about 100 nm, or from about 50 nm to about 100 nm. In certain embodiments, the particle size of the silicon-based material is less than 500 nm, less than 400 nm, less than 300 nm, less than 200 nm, less than 150 nm, less than 100 nm, or less than 50 nm.

In certain embodiments, the weight ratio of the silicon-based material to the porous carbon aerogel is from about 1:1 to about 10:1, from about 5:1 to about 10:1, from about 1:1 to about 8:1, from about 1:1 to about 5:1, or from about 1:1 to about 3:1. In some embodiments, the weight ratio of the silicon-based material to the porous carbon aerogel is less than 10:1, less than 8:1, less than 6:1, less than 4:1, or less than 2:1. In certain embodiments, the weight ratio the silicon-based material to the porous carbon aerogel is at least 1:1, at least 2:1, at least 4:1, at least 6:1, or at least 8:1.

To provide sufficient space for the expansion of the silicon-based material during intercalation of lithium ions, the pore size of the porous carbon aerogel is larger than the particle size of the silicon-based material. Also, to prevent agglomeration of the silicon-based material in the pores of the porous carbon aerogel, the ratio of the pore size of the porous carbon aerogel to the particle size of the silicon-based material is less than 20:1. In some embodiments, the ratio of the pore size of the porous carbon aerogel to the particle size of the silicon-based material is from about 2:1 to about 50:1, from about 2:1 to about 20:1, from about 2:1 to about 10:1, from about 2:1 to about 8:1, from about 2:1 to about 7:1, from about 2:1 to about 5:1, from about 3:1 to about 10:1, or from about 3:1 to about 7:1. In certain embodiments, the ratio of the pore size of the porous carbon aerogel to the particle size of the silicon-based material is at least 1:1, at least 2:1, at least 3:1, or at least 4:1. In some embodiments, the ratio of the pore size of the porous carbon aerogel to the particle size of the silicon-based material is less than 20:1, less than 15:1, or less than 10:1.

The second suspension is then homogenized by a homogenizer to achieve uniform mixing of the porous carbon material and silicon-based material and promote effective diffusion of the silicon-based material into the pores of the porous carbon material. Any equipment that can homogenize the second suspension can be used herein. In some embodiments, the homogenizer is an ultrasonicator, a stirring mixer, planetary mixer, a blender, a mill, a rotor-stator homogenizer, a high pressure homogenizer, or a combination thereof.

In some embodiments, the homogenizer is an ultrasonicator. Any ultrasonicator that can apply ultrasound energy to agitate and disperse particles in a sample can be used herein. In certain embodiments, the ultrasonicator is an ultrasonic bath, a probe-type ultrasonicator, or an ultrasonic flow cell.

In certain embodiments, the ultrasonicator is operated at a power density from about 20 W/L to about 200 W/L, from about 20 W/L to about 150 W/L, from about 20 W/L to about 100 W/L, from about 20 W/L to about 50 W/L, from about 50 W/L to about 200 W/L, from about 50 W/L to about 150 W/L, from about 50 W/L to about 100 W/L, from about 10 W/L to about 50 W/L, or from about 10 W/L to about 30 W/L.

In some embodiments, the second suspension is sonicated for a time period from about 0.5 hour to about 5 hours, from about 0.5 hour to about 3 hours, from about 0.5 hour to about 2 hours, from about 1 hour to about 5 hours, from about 1 hour to about 3 hours, from about 1 hour to about 2 hours, from about 2 hours to about 5 hours, or from about 2 hours to about 4 hours.

In certain embodiments, the second suspension is homogenized by mechanical stirring for a time period from about 0.5 hour to about 5 hours. In some embodiments, the stirring mixer is a planetary mixer consisting of planetary and high speed dispersion blades. In certain embodiments, the rotational speed of planetary and high speed dispersion blades is the same. In other embodiments, the rotational speed of the planetary blade is from about 30 rpm to about 200 rpm and rotational speed of the dispersion blade is from about 1,000 rpm to about 3,500 rpm. In certain embodiments, the stirring time is from about 0.5 hour to about 5 hours, from about 1 hour to about 5 hours, from about 2 hours to about 5 hours, or from about 3 hours to about 5 hours.

In some embodiments, the second suspension is homogenized by mechanical stirring and ultrasonication simultaneously. In certain embodiments, the second suspension is ultrasonicated and stirred at room temperature for several hours. The combined effects of mechanical stirring and ultrasonication can enhance mixing effect and hence mixing time could be reduced. In certain embodiments, the time for stirring and ultrasonication is from about 0.5 hour to about 5 hours, from about 0.5 hour to about 4 hours, from about 0.5 hour to about 3 hours, from about 0.5 hour to about 2 hours, from about 0.5 hour to about 1 hour, from about 1 hour to about 4 hours, from about 1 hour to about 3 hours, or from about 1 hour to about 2 hours.

During the operation of ultrasonicator, ultrasound energy is converted partially into heat, causing an increase in the temperature in the suspension. Conventionally, a cooling system is used for dissipating the heated generated. In order to maintain the suspension temperature during ultrasonication, a bath of ice may be used. Furthermore, a shorter duration for ultrasonication may be used to prevent overheating the suspension due to generation of large amounts of heat. The suspension can also be ultrasonicated intermittently to avoid overheating. However, when a higher power is applied, considerable amount of heat can be generated due to larger oscillation amplitude. Therefore, it becomes more difficult to cool the suspension.

The homogeneity of the silicon-based material and the porous carbon aerogel in the second suspension depends on the ultrasound energy delivered to the suspension. The ultrasonic power cannot be too high as the heat generated by ultrasonication may overheat the suspension. A temperature rise during ultrasonication may affect the dispersion quality of particles in the second suspension.

The ultrasonicator can be operated at a low power density to avoid overheating of the second suspension. In some embodiments, the second suspension is treated by the ultrasonicator at a power density of about 20 W/L to about 200 W/L with stirring at a rotational speed of the dispersion blade from about 1,000 rpm to about 3,500 rpm and rotational speed of the planetary blade from about 40 rpm to about 200 rpm. In other embodiments, the ultrasonicator is operated at a power density from about 20 W/L to about 150 W/L, from about 20 W/L to about 100 W/L, from about 20 W/L to about 50 W/L, from about 50 W/L to about 200 W/L, from about 50 W/L to about 150 W/L, from about 50 W/L to about 100 W/L, from about 10 W/L to about 50 W/L, or from about 10 W/L to about 30 W/L. In some embodiments, the ultrasonicator is operated at a power density from about 10 W/L to about 50 W/L. When such power densities are used, heat removal or cooling is not required for the dispersing step. In certain embodiments, the rotational speed of the dispersion blade is from about 1,000 rpm to about 3,000 rpm, from about 1,000 rpm to about 2,000 rpm, from about 2,000 rpm to about 3,500 rpm, or from about 3,000 rpm to about 3,500 rpm. In some embodiments, the rotational speed of the planetary blade is from about 30 rpm to about 150 rpm, from about 30 rpm to about 100 rpm, from about 30 rpm to about 75 rpm, from about 75 rpm to about 200 rpm, from about 75 rpm to about 150 rpm, from about 100 rpm to about 200 rpm, or from about 100 rpm to about 150 rpm.

In some embodiments, the second suspension has a solid content from about 1% to about 20%, from about 1% to about 15%, from about 1% to about 10%, from about 5% to about 20%, or from about 5% to about 15% by weight, based on the total weight of the second suspension.

In certain embodiments, the third suspension is prepared by dispersing a binder material in the homogenized second suspension. The binder material performs a role of binding the porous carbon aerogel and active electrode material together on the current collector. In some embodiments, the binder material is selected from the group consisting of styrene-butadiene rubber (SBR), acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose (CMC), hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid (PAA), polyacrylate, polymethacrylic acid, polymethacrylate, polyacrylamide, polyurethane, fluorinated polymer, chlorinated polymer, a salt of alginic acid, polyvinylidene fluoride (PVDF), poly(vinylidene fluoride)-hexafluoropropene (PVDF-HFP), and combinations thereof. In certain embodiments, the salt of alginic acid comprises a cation selected from the group consisting of Na, Li, K, Ca, NH₄, Mg, Al, or a combination thereof.

In some embodiments, the binder material is SBR, CMC, PAA, a salt of alginic acid, or a combination thereof. In certain embodiments, the binder material is acrylonitrile copolymer. In some embodiments, the binder material is polyacrylonitrile. In certain embodiments, the binder material is free of SBR, CMC, PVDF, acrylonitrile copolymer, PAA, polyacrylonitrile, PVDF-HFP, latex, or a salt of alginic acid.

A carbon active material is used as an anode active material. In some embodiments, the anode slurry can be prepared by dispersing a carbon active material in the third suspension. In certain embodiments, the carbon active material is selected from the group consisting of hard carbon, soft carbon, graphite, artificial graphite, natural graphite, mesocarbon microbeads, and combinations thereof. In some embodiments, the carbon active material is not hard carbon, soft carbon, graphite, or mesocarbon microbeads.

In some embodiments, the particle size of the carbon active material is from about 1 μm to about 30 μm, from about 1 μm to about 20 μm, from about 1 μm to about 10 μm, from about 5 μm to about 25 μm, from about 5 μm to about 20 μm, from about 10 μm to about 30 μm, or from about 10 μm to about 20 μm. In certain embodiments, the particle size of the carbon active material is at least 1 μm, at least 5 μm, at least 10 μm, at least 15 μm, or at least 20 μm.

The solvent used in the anode slurry can be any polar organic solvent. In certain embodiments, the solvent is a polar organic solvent selected from the group consisting of methyl propyl ketone, methyl isobutyl ketone, ethyl propyl ketone, diisobutyl ketone, acetophenone, N-methyl-2-pyrrolidone, acetone, tetrahydrofuran, dimethylformamide, acetonitrile, dimethyl sulfoxide, and the like.

An aqueous solvent can also be used for producing the anode slurry. Transition to an aqueous-based process may be desirable to reduce emissions of volatile organic compound, and increase processing efficiency. In certain embodiments, the solvent is a solution containing water as the major component and a volatile solvent, such as alcohols, lower aliphatic ketones, lower alkyl acetates or the like, as the minor component in addition to water. In some embodiments, the amount of water is at least 50%, at least 55%, at least 60%, at least 65%, at least 70%, at least 75%, at least 80%, at least 85%, at least 90%, or at least 95% to the total amount of water and solvents other than water. In certain embodiments, the amount of water is at most 55%, at most 60%, at most 65%, at most 70%, at most 75%, at most 80%, at most 85%, at most 90%, or at most 95% to the total amount of water and solvents other than water. In some embodiments, the solvent consists solely of water, that is, the proportion of water in the solvent is 100 vol. %.

Any water-miscible solvents can be used as the minor component of the solvent. Some non-limiting examples of the minor component (i.e., solvents other than water) include alcohols, lower aliphatic ketones, lower alkyl acetates and combinations thereof. Some non-limiting examples of the alcohol include C₁-C₄ alcohols, such as methanol, ethanol, isopropanol, n-propanol, butanol, and combinations thereof. Some non-limiting examples of the lower aliphatic ketones include acetone, dimethyl ketone, and methyl ethyl ketone. Some non-limiting examples of the lower alkyl acetates include ethyl acetate, isopropyl acetate, and propyl acetate.

Some non-limiting examples of water include tap water, bottled water, purified water, pure water, distilled water, de-ionized water, D₂O, or a combination thereof. In some embodiments, the solvent is purified water, pure water, de-ionized water, distilled water, or a combination thereof. In certain embodiments, the solvent is free of an organic solvent such as alcohols, lower aliphatic ketones, lower alkyl acetates. Since the composition of the anode slurry does not contain any organic solvent, expensive, restrictive and complicated handling of organic solvents is avoided during the manufacture of the slurry.

In certain embodiments, the anode slurry further comprises a dispersant to achieve uniform dispersion of the porous carbon aerogel and the silicon-based material. In some embodiments, the method further comprises a step of dispersing a dispersant in the solvent to form a dispersant solution before dispersing the porous carbon aerogel. In certain embodiments, the dispersant is an acrylate-based or a cellulose-based polymer. Some non-limiting examples of the acrylic-based polymer include polyvinyl pyrrolidone, polyacrylic acid, and polyvinyl alcohol. Some non-limiting examples of the cellulose-based polymer include hydroxyethyl cellulose (HEC), hydroxypropyl cellulose (HPC), methyl cellulose (MC), and hydroxyalkyl methyl cellulose. In further embodiments, the dispersant is selected from the group consisting of polyvinyl alcohol, polyethylene oxide, polypropylene oxide, polyvinyl pyrrolidone, polyanionic cellulose, carboxylmethyl cellulose, hydroxyethyl cellulose, carboxymethyl hydroxyethyl cellulose, methyl cellulose, starch, pectin, polyacrylamide, gelatin, polyacrylic acid, and combinations thereof.

The use of the dispersant enhances wetting of the porous carbon aerogel and helps the porous carbon aerogel disperse in the dispersant solution. The addition of surfactants such as an anionic surfactant or a cationic surfactant, however, tends to change other physical properties of the dispersion solution (such as surface tension), and may render the dispersion solution unsuitable for a desired application. Additionally, the use of the dispersant may also help inhibit the settling of solid contents by increasing the viscosity of the dispersion solution. Therefore, constant viscosities in the dispersion solution and a uniform dispersion state may be retained for a long time.

In some embodiments, the viscosity of the dispersant solution is from about 10 mPa·s to about 2,000 mPa·s, from about 10 mPa·s to about 1,500 mPa·s, from about 10 mPa·s to about 1,000 mPa·s, from about 10 mPa·s to about 500 mPa·s, from about 10 mPa·s to about 300 mPa·s, from about 10 mPa·s to about 100 mPa·s, from about 10 mPa·s to about 80 mPa·s, from about 10 mPa·s to about 60 mPa·s, from about 10 mPa·s to about 40 mPa·s, from about 10 mPa·s to about 30 mPa·s, or from about 10 mPa·s to about 20 mPa·s.

In certain embodiments, the weight ratio of the porous carbon aerogel to the dispersant in the first suspension is from about 1:5 to about 5:1, from about 1:1 to about 5:1, or from about 1:1 to about 1:5.

The amount of the dispersant in the anode slurry is from about 0.1% to about 10%, or from about 0.1% to about 5% by weight, based on the total weight of the anode slurry. When the amount of the dispersant is too high, the weight ratio of the dispersant to the active material is increased, and thus the weight ratio of the active material is reduced. This results in the reduction of a cell capacity and the deterioration of cell properties. In certain embodiments, the amount of the dispersant in the anode slurry is from about 0.1% to about 4%, from about 0.1% to about 3%, from about 0.1% to about 2%, or from about 0.1% to about 1% by weight, based on the total weight of the anode slurry. In some embodiments, the amount of the dispersant in the anode slurry is about 0.1%, about 0.5%, about 1%, about 2%, about 3%, about 4%, or about 5% by weight, based on the total weight of the anode slurry.

In certain embodiments, each of the first suspension, the second suspension, the third suspension and the anode slurry are independently free of a dispersant or surfactant. In other embodiments, each of the first suspension, the second suspension, the third suspension and the anode slurry are independently free of a cationic surfactant or an anionic surfactant.

In some embodiments, the anode slurry has a solid content from about 25% to about 65%, from about 30% to about 65%, from about 30% to about 60%, from about 30% to about 55%, from about 30% to about 50%, from about 35% to about 60%, from about 35% to about 50%, or from about 40% to about 55% by weight, based on the total weight of the anode slurry. In certain embodiments, the anode slurry has a solid content of about 25%, about 30%, about 35%, about 40%, about 45%, about 50%, about 55%, about 60%, or about 65% by weight, based on the total weight of the anode slurry.

In certain embodiments, the porous carbon aerogel in the anode slurry is present in an amount from about 0.1% to about 10%, from about 0.1% to about 5%, from about 0.1% to about 2.5%, from about 0.1% to about 1%, from about 0.5% to about 3%, from about 0.5% to about 1%, from about 1% to about 5%, from about 1% to about 4%, or from about 1% to about 3% by weight, based on the total weight of the anode slurry. In some embodiments, the porous carbon aerogel in the anode slurry is less than 10%, less than 8%, less than 5%, less than 3%, or less than 1% by weight, based on the total weight of the anode slurry. In certain embodiments, the porous carbon aerogel in the anode slurry is at least 0.1%, at least 0.3%, at least 0.5%, at least 0.7%, at least 0.9%, or at least 1% by weight, based on the total weight of then anode slurry.

In some embodiments, the amount of the silicon-based material in the anode slurry is from about 1% to about 10%, from about 1% to about 8%, from about 1% to about 5%, from about 2% to about 8%, from about 2% to about 6%, or from about 2% to about 5% by weight, based on the total weight of the anode slurry. In certain embodiments, the amount of the silicon-based material in the anode slurry is less than 10%, less than 5%, less than 4%, less than 3%, less than 2%, less than 1%, less than 0.5%, or less than 0.1% by weight, based on the total weight of the anode slurry. In some embodiments, the amount of the silicon-based material in the anode slurry is at most 0.1%, at most 0.5%, at most 1%, at most 2%, at most 3%, at most 4%, at most 5%, or at most 10% by weight, based on the total weight of the anode slurry. If the silicon content is too high in the anode slurry, this may undesirably lead to excessive volume expansion of the electrode during intercalation of lithium ions and may, in turn, cause separation of the electrode layer from the current collector.

In certain embodiments, the silicon-based material is present in an amount from about 0.1% to about 10%, from about 0.1% to about 5%, from about 1% to about 10%, from about 1% to about 5%, from about 3% to about 10%, or from about 5% to about 10% by weight, based on the total weight of the anode slurry.

In some embodiments, the amount of binder material in the anode slurry is from about 1% to about 20%, from about 1% to about 15%, from about 1% to about 10%, from about 1% to about 5%, from about 2% to about 10%, from about 2% to about 5%, from about 2% to about 4%, from about 5% to about 15%, from about 5% to about 10%, from about 10% to about 20%, from about 10% to about 15%, or from about 15% to about 20% by weight, based on the total weight of the anode slurry. In certain embodiments, the amount of the binder material in the anode slurry is less than 10%, less than 8%, less than 5%, less than 4%, or less than 3% by weight, based on the total weight of the anode slurry. In some embodiments, the amount of the binder material in the anode slurry is at least 0.5%, at least 1%, at least 1.5%, at least 2%, at least 3%, or at least 5% by weight, based on the total weight of the anode slurry. If the amount of the binder material is less than 1% by weight, binding strength is insufficient, causing separation of the active material from the current collector. If the amount of the binder material is more than 20% by weight, the impedance of the anode will increase and the battery performance will deteriorate.

In certain embodiments, the amount of the carbon active material in the anode slurry is at least 40%, at least 50%, at least 55%, at least 60%, at least 65%, at least 70%, at least 75%, at least 80%, at least 85%, at least 90%, or at least 95% by weight, based on the total weight of the anode slurry. In other embodiments, the amount of the carbon active material in the anode slurry is from about 40% to about 95%, from about 40% to about 85%, from about 50% to about 95%, from about 50% to about 90%, from about 60% to about 95%, from about 70% to about 95%, from about 80% to about 95%, from about 50% to about 85%, from about 60% to about 85%, or from about 70% to about 95% by weight, based on the total weight of the anode slurry.

The anode slurry can be prepared by any suitable method, for example, by reversing the order of adding a binder material and a carbon active material, in which the carbon active material is added to the homogenized second suspension to prepare the third suspension, and a binder material is added to the third suspension to prepare the anode slurry.

In another aspect, provided herein is a method of preparing an anode slurry, comprising the steps of:

1) dispersing a porous carbon aerogel in a solvent to form a first suspension;

2) dispersing a silicon-based material in the first suspension to form a second suspension;

3) homogenizing the second suspension by a homogenizer to form a homogenized second suspension;

4) dispersing a carbon active material in the homogenized second suspension to form a third suspension; and

5) dispersing a binder material in the third suspension to form the anode slurry;

wherein the porous carbon aerogel has an average pore size from about 80 nm to about 500 nm.

Also provided herein is a negative electrode for a lithium-ion battery, the negative electrode comprising: an anode current collector; and an anode electrode layer coated on the anode current collector, wherein the anode electrode layer is formed using the anode slurry prepared by the method disclosed herein.

Also provided herein is a lithium-ion battery comprising: at least one cathode; at least one anode; and at least one separator interposed between the at least one cathode and the at least one anode, wherein the at least one anode is the negative electrode prepared by the anode slurry disclosed herein.

The following examples are presented to exemplify embodiments of the invention. All numerical values are approximate. When numerical ranges are given, it should be understood that embodiments outside the stated ranges may still fall within the scope of the invention. Specific details described in each example should not be construed as necessary features of the invention.

### EXAMPLES

The thickness of anode electrode layers of coin cells and thickness of pouch cells were measured by a micrometer having a measuring range from 0 mm to 25 mm (293-240-30, Mitutoyo Corporation, Japan).

The determination of the solid content of an anode slurry involved drying followed by a weighing operation to determine the weight of the solids in a given weight of the slurry. A given weight of the slurry (10 g) was dried to constant weight using a vacuum drying oven (DZF-6050, Shanghai Hasuc Instrument Manufacture Co., Ltd., China) at 105° C. for 4 hours. The weight of the solids of the dried slurry was then measured. Similarly, the solid contents of the dispersant solution and first, second and third suspension were obtained.

### Example 1

### A) Preparation of a Dispersant Solution

A dispersant solution was prepared by dissolving 0.1 kg of polyvinyl alcohol (PVA; obtained from Aladdin Industries Corporation, China) in 10 L deionized water. The dispersant solution had a viscosity of 20 mPa·s and a solid content of 1.0 wt. %.

### B) Preparation of a First Suspension

A first suspension was prepared by dispersing 0.1 kg of carbonized resorcinol-formaldehyde (CRF) aerogel (obtained from Shaanxi Unita Nano-New Materials Co., Ltd., China) in the dispersant solution while stirring with a 20 L planetary mixer (CM20; obtained from ChienMei Co. Ltd., China). After the addition, the first suspension was further stirred for about 1 hour at room temperature at a planetary blade speed of 40 rpm and a dispersion blade speed of 2,500 rpm. The carbon aerogel had a pore size of 100 nm, porosity of 80%, density of 0.1 g/cm², specific surface area of 1,200 m²/g and electrical conductivity of 10 S/cm. The first suspension had a solid content of 2.0 wt. %.

### C) Preparation of a Second Suspension

A second suspension was prepared by dispersing 0.5 kg of silicon (obtained from CWNANO Co. Ltd., China) having a particle size of 50 nm in the first suspension. The second suspension had a solid content of 6.5 wt. %. After the addition, the second suspension was ultrasonicated by a 30 L ultrasonicator (G-100ST; obtained from Shenzhen Geneng Cleaning Equipment Co. Ltd., China) at a power density of 20 W/L and stirred by a 20 L planetary mixer simultaneously at room temperature for about 2 hours to obtain a homogenized second suspension. The stirring speed of the planetary blade was 40 rpm and the stirring speed of the dispersion blade was 2,500 rpm.

The solid contents of the upper portion and the lower portion of the second suspension of Example 1 were measured. The results are shown in Table 2 below.

### D) Preparation of a Third Suspension

A third suspension was prepared by dispersing 0.3 kg of polyacrylic acid (PAA; #181285, obtained from Sigma-Aldrich, US) in the homogenized second suspension and then stirred by a 20 L planetary mixer at a planetary blade speed of 40 rpm and a dispersion blade speed of 2,500 rpm for 0.5 hour. The third suspension had a solid content of 9.1 wt. %.

### E) Preparation of an Anode Slurry

An anode slurry was prepared by dispersing 9 kg of artificial graphite (AGPH, obtained from RFT Technology Co. Ltd., China) having a particle size of 15 μm in the third suspension and then stirred by a 20 L planetary mixer at a planetary blade speed of 40 rpm and a dispersion blade speed of 2,500 rpm at room temperature for 0.5 hour. The solid content of the anode slurry was 50.0 wt. %.

The solid contents of the upper portion and the lower portion of the anode slurry of Example 1 were measured. The test results are shown in Table 3 below.

### F) Assembling of Coin Cells

A negative electrode was prepared by coating the anode slurry onto one side of a copper foil having a thickness of 9 μm using a doctor blade coater (MSK-AFA-III; obtained from Shenzhen KejingStar Technology Ltd., China) with an area density of about 7 mg/cm². The coated film on the copper foil was dried by an electrically heated conveyor oven set at 90° C. for 2 hours.

The electrochemical performance of the anode prepared by the method described in Example 1 was tested in CR2032 coin cells assembled in an argon-filled glove box. The coated anode sheet was cut into disc-form negative electrodes for coin cell assembly. A lithium metal foil having a thickness of 500 μm was used as a counter electrode. The electrolyte was a solution of LiPF₆ (1 M) in a mixture of ethylene carbonate (EC), ethyl methyl carbonate (EMC) and dimethyl carbonate (DMC) in a volume ratio of 1:1:1.

The discharge capacities of the coin cells of Example 1 were measured and are shown in Table 4 below. The volume expansion of the anode layer of the coin cells of Example 1 at the end of the first and twentieth charging processes were measured and the results are shown in Table 5 below.

### G) Preparation of a Pouch Cell

### I) Preparation of Negative Electrode

The anode slurry was coated onto both sides of a copper foil having a thickness of 9 μm using a transfer coater with an area density of about 15 mg/cm². The coated films on the copper foil were dried at about 80° C. for 2.4 minutes by a 24-meter-long conveyor hot air dryer operated at a conveyor speed of about 10 meters/minute to obtain a negative electrode.

### II) Preparation of Positive Electrode Slurry

A positive electrode slurry was prepared by mixing 92 wt. % cathode material (LiMn₂O₄; obtained from HuaGuan HengYuan LiTech Co. Ltd., Qingdao, China), 4 wt. % carbon black (SuperP; obtained from Timcal Ltd, Bodio, Switzerland) as a conductive agent, and 4 wt. % polyvinylidene fluoride (PVDF; Solef® 5130, obtained from Solvay S.A., Belgium) as a binder, which were dispersed in N-methyl-2-pyrrolidone (NMP; purity of >99%, Sigma-Aldrich, US) to form a slurry with a solid content of 50 wt. %. The slurry was homogenized by a planetary mixer.

### III) Preparation of Positive Electrode

The homogenized slurry was coated onto both sides of an aluminum foil having a thickness of 20 μm using a transfer coater with an area density of about 30 mg/cm². The coated films on the aluminum foil were dried for 6 minutes by a 24-meter-long conveyor hot air drying oven as a sub-module of the transfer coater operated at a conveyor speed of about 4 meters/minute to obtain a positive electrode. The temperature-programmed oven allowed a controllable temperature gradient in which the temperature gradually rose from the inlet temperature of 65° C. to the outlet temperature of 80° C.

### IV) Assembling of a Pouch Cell

After drying, the resulting cathode film and anode film of Example 1 were used to prepare the cathode and anode respectively by cutting them into individual electrode plates. A pouch cell was assembled by stacking the cathode and anode electrode plates alternatively and then packaged in a case made of an aluminum-plastic laminated film. The cathode and anode electrode plates were kept apart by separators and the case was pre-formed. An electrolyte was then filled into the case holding the packed electrodes in high-purity argon atmosphere with moisture and oxygen content less than 1 ppm. The electrolyte was a solution of LiPF₆ (1 M) in a mixture of ethylene carbonate (EC), ethyl methyl carbonate (EMC) and dimethyl carbonate (DMC) in a volume ratio of 1:1:1. After electrolyte filling, the pouch cell was vacuum sealed and then mechanically pressed using a punch tooling with standard square shape.

The volume expansions of the pouch cell of Example 1 at the end of the first and twentieth charging processes were measured and the results are shown in Table 6 below.

### Example 2

A coin cell and pouch cell were prepared in the same manner as in Example 1, except that graphene aerogel was used instead of carbonized resorcinol-formaldehyde aerogel when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 3

A coin cell and pouch cell were prepared in the same manner as in Example 1, except that carbon nanotube aerogel was used instead of carbonized resorcinol-formaldehyde aerogel when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 4

A coin cell and pouch cell were prepared in the same manner as in Example 1, except that silicon carbon composite (Si/C) was used instead of silicon (Si) when preparing the second suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 5

A coin cell and pouch cell were prepared in the same manner as in Example 1, except that N-methyl-2-pyrrolidone (NMP) was used instead of water as a solvent, and polyvinylidene fluoride (PVDF) was used instead of polyacrylic acid (PAA) as a binder material. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 6

### A) Preparation of a Dispersant Solution

A dispersant solution was prepared by dissolving 0.1 kg of carboxymethyl cellulose (CMC; BSH-12; obtained from DKS Co. Ltd., Japan) in 10 L deionized water. The dispersant solution had a viscosity of 2,000 mPa·s and a solid content of 1.0 wt. %.

### B) Preparation of a First Suspension

A first suspension was prepared by dispersing 0.1 kg of carbonized resorcinol-formaldehyde (CRF) aerogel (obtained from Shaanxi Unita Nano-New Materials Co., Ltd., China) in the dispersant solution while stirring with a 20 L planetary mixer (CM20; obtained from ChienMei Co. Ltd., China). After the addition, the first suspension was further stirred for about 1 hour at room temperature at a planetary blade speed of 40 rpm and a dispersion blade speed of 2,500 rpm. The carbon aerogel had a pore size of 100 nm, porosity of 80%, density of 0.1 g/cm², specific surface area of 1,200 m²/g and electrical conductivity of 10 S/cm. The first suspension had a solid content of 2.0 wt. %.

### C) Preparation of a Second Suspension

A second suspension was prepared by dispersing 0.5 kg of silicon (obtained from CWNANO Co. Ltd., China) having a particle size of 50 nm in the first suspension. The second suspension had a solid content of 6.5 wt. %. After the addition, the second suspension was ultrasonicated by a 30 L ultrasonicator (G-100ST; obtained from Shenzhen Geneng Cleaning Equipment Co. Ltd., China) at a power density of 20 W/L and stirred by a 20 L planetary mixer simultaneously at room temperature for about 2 hours to obtain a homogenized second suspension. The stirring speed of the planetary blade was 40 rpm and the stirring speed of the dispersion blade was 2,500 rpm. The solid contents of the upper portion and the lower portion of the second suspension of Example 6 were measured.

### D) Preparation of a Third Suspension

A third suspension was prepared by dispersing 9 kg of artificial graphite (AGPH, obtained from RFT Technology Co. Ltd., China) having a particle size of 15 μm in the homogenized second suspension and then stirred by a 20 L planetary mixer at a planetary blade speed of 40 rpm and a dispersion blade speed of 2,500 rpm for 0.5 hour. The third suspension had a solid content of 49.2 wt. %.

### E) Preparation of an Anode Slurry

An anode slurry was prepared by dispersing 0.3 kg of styrene-butadiene rubber (SBR; AL-2001; NIPPON A&L INC., Japan) in the third suspension and then stirred by a 20 L planetary mixer at a planetary blade speed of 40 rpm and a dispersion blade speed of 2,500 rpm at room temperature for 0.5 hour. The solid content of the anode slurry was 50.0 wt. %. The solid contents of the upper portion and the lower portion of the anode slurry of Example 6 were measured. The results are shown in Table 3 below.

A coin cell and pouch cell were prepared in the same manner as in Example 1.

### Example 7

A coin cell and pouch cell were prepared in the same manner as in Example 1, except that 0.8 kg of silicon was used instead of 0.5 kg of silicon when preparing the second suspension. The solid contents of the dispersant solution, first suspension, second suspension, third suspension, and anode slurry were 1.0 wt. %, 2.0 wt. %, 9.1 wt. %, 11.5 wt. %, and 50.7 wt. %, respectively.

### Example 8

A coin cell and pouch cell were prepared in the same manner as in Example 1, except that 1 kg of silicon was used instead of 0.5 kg of silicon when preparing the second suspension. The solid contents of the dispersant solution, first suspension, second suspension, third suspension, and anode slurry were 1.0 wt. %, 2.0 wt. %, 10.7 wt. %, 13.0 wt. %, and 51.2 wt. %, respectively.

### Example 9

A coin cell and pouch cell were prepared in the same manner as in Example 1, except that a carbonized resorcinol-formaldehyde aerogel having a porosity of 50% was used instead of a carbonized resorcinol-formaldehyde aerogel having a porosity of 80% when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 10

A coin cell and pouch cell were prepared in the same manner as in Example 1, except that a dispersant was not added and carbonized phenol-formaldehyde (CPF) aerogel was used instead of a carbonized resorcinol-formaldehyde aerogel when preparing the first suspension. The solid contents of the first suspension, second suspension, third suspension, and anode slurry were 1.0 wt. %, 5.7 wt. %, 8.3 wt. %, and 49.7 wt. %, respectively.

### Example 11

A coin cell and pouch cell were prepared in the same manner as in Example 1, except that a dispersant was not added and a carbonized N-doped resorcinol formaldehyde (carbonized N-doped RF) aerogel was used instead of a carbonized resorcinol-formaldehyde aerogel when preparing the first suspension. The solid contents of the first suspension, second suspension, third suspension, and anode slurry were 1.0 wt. %, 5.7 wt. %, 8.3 wt. %, and 49.7 wt. %, respectively.

### Example 12

A coin cell and pouch cell were prepared in the same manner as in Example 1, except that a dispersant was not added and a carbonized resorcinol-formaldehyde aerogel having a pore size of 200 nm was used instead of a carbonized resorcinol-formaldehyde aerogel having a pore size of 100 nm. The solid contents of the first suspension, second suspension, third suspension, and anode slurry were 1.0 wt. %, 5.7 wt. %, 8.3 wt. %, and 49.7 wt. %, respectively.

### Example 13

A coin cell and pouch cell were prepared in the same manner as in Example 1, except that a carbonized resorcinol-formaldehyde aerogel having a pore size of 200 nm was used instead of a carbonized resorcinol-formaldehyde aerogel having a pore size of 100 nm when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 14

A coin cell and pouch cell were prepared in the same manner as in Example 1, except that a carbonized resorcinol-formaldehyde aerogel having a pore size of 250 nm was used instead of a carbonized resorcinol-formaldehyde aerogel having a pore size of 100 nm when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 15

A coin cell and pouch cell were prepared in the same manner as in Example 1, except that a carbonized resorcinol-formaldehyde aerogel having a pore size of 350 nm was used instead of a carbonized resorcinol-formaldehyde aerogel having a pore size of 100 nm when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 16

A coin cell and pouch cell were prepared in the same manner as in Example 1, except that a carbonized resorcinol-formaldehyde aerogel having pores exhibiting a bimodal size distribution with two pore diameter peaks was used instead of a carbonized resorcinol-formaldehyde aerogel having a pore size of 100 nm when preparing the first suspension. The two pore diameter peaks are respectively 100 nm (a first average pore diameter) and 200 nm (a second average pore diameter). The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Example 17

A coin cell and pouch cell were prepared in the same manner as in Example 1, except that a mixture of carbonized resorcinol-formaldehyde aerogels comprising 0.05 kg of a first porous carbon aerogel having a pore size of 100 nm and 0.05 kg of a second porous carbon aerogel having a pore size of 200 nm was used instead of 0.1 kg of carbonized resorcinol-formaldehyde aerogel having a pore size of 100 nm when preparing the first suspension. The solid contents of the dispersant solution, first suspension, second suspension, third suspension, and anode slurry were 1.0 wt. %, 2.0 wt. %, 6.5 wt. %, 9.1 wt. %, and 50.0 wt. %, respectively.

### Comparative Example 1

A coin cell and pouch cell were prepared in the same manner as in Example 1, except that carbon black (SuperP; obtained from Timcal Ltd, Bodio, Switzerland) was used instead of carbonized resorcinol-formaldehyde aerogel when preparing the first suspension.

### Comparative Example 2

A coin cell and pouch cell were prepared in the same manner as in Example 5, except that carbon black (SuperP; obtained from Timcal Ltd, Bodio, Switzerland) was used instead of carbonized resorcinol-formaldehyde aerogel.

### Comparative Example 3

A coin cell and pouch cell were prepared in the same manner as in Example 1, except that carbonized resorcinol-formaldehyde aerogel (obtained from Shaanxi Unita Nano-New Materials Co., Ltd., China) having a pore size of 30 nm was used instead of carbonized resorcinol-formaldehyde aerogel having a pore size of 100 nm when preparing the first suspension.

### Comparative Example 4

A coin cell and pouch cell were prepared in the same manner as in Example 1, except that the order of adding the porous carbon aerogel and silicon-based material was reversed. Silicon (0.5 kg) was used instead of carbonized resorcinol-formaldehyde aerogel when preparing the first suspension, and carbonized resorcinol-formaldehyde aerogel (0.1 kg) was used instead of silicon when preparing the second suspension.

### Comparative Example 5

A coin cell and pouch cell were prepared in the same manner as in Example 1, except that graphite was added when preparing the anode slurry instead of silicon.

The formulations of Examples 1-17 and Comparative Examples 1-5 are shown in Table 1. The solid contents of the upper portion and the lower portion of the second suspension of Examples 1-17 and Comparative Examples 1-5 were measured and are shown in Table 2 below. The solid contents of the upper portion and the lower portion of the anode slurry of Examples 1-17 and Comparative Examples 1-5 were measured and are shown in Table 3 below. The discharge capacities of the coin cells of Examples 1-17 and Comparative Examples 1-5 were measured and are shown in Table 4 below. The volume expansions of the anode layer of the coin cells of Examples 1-17 and Comparative Examples 1-5 at the end of the first and twentieth charging processes were measured and are shown in Table 5 below. The volume expansions of the pouch cell of Examples 1-17 and Comparative Examples 1-5 at the end of the first and twentieth charging processes were measured and are shown in Table 6 below.

TABLE 1

| | Silicon- | | | | | |
|---|---|---|---|---|---|---|
| | based | | | Binder | Porous carbon | Pore size of porous |
| | material¹ | Dispersant | Solvent | material | aerogel² | carbon aerogel (nm) |
| Example 1 | Si | PVA | H₂O | PAA | CRF aerogel | 100 |
| Example 2 | Si | PVA | H₂O | PAA | Graphene | 100 |
| | | | | | aerogel | |
| Example 3 | Si | PVA | H₂O | PAA | Carbon | 100 |
| | | | | | nanotube | |
| | | | | | aerogel | |
| Example 4 | Si/C | PVA | H₂O | PAA | CRF aerogel | 100 |
| Example 5 | Si | PVA | NMP | PVDF | CRF aerogel | 100 |
| Example 6 | Si | CMC | H₂O | SBR | CRF aerogel | 100 |
| Example 7 | Si | PVA | H₂O | PAA | CRF aerogel | 100 |
| Example 8 | Si | PVA | H₂O | PAA | CRF aerogel | 100 |
| Example 9 | Si | PVA | H₂O | PAA | CRF aerogel | 100 |
| Example 10 | Si | / | H₂O | PAA | CPF aerogel | 100 |
| Example 11 | Si | / | H₂O | PAA | Carbonized N- | 100 |
| | | | | | doped RF | |
| | | | | | aerogel | |
| Example 12 | Si | / | H₂O | PAA | CRF aerogel | 200 |
| Example 13 | Si | PVA | H₂O | PAA | CRF aerogel | 200 |
| Example 14 | Si | PVA | H₂O | PAA | CRF aerogel | 250 |
| Example 15 | Si | PVA | H₂O | PAA | CRF aerogel | 350 |
| Example 16 | Si | PVA | H₂O | PAA | CRF aerogel | Bimodal (100, 200) |
| Example 17 | Si | PVA | H₂O | PAA | CRF aerogel | Mixture |
| | | | | | | First aerogel: 100 |
| | | | | | | Second aerogel: 200 |
| Comparative | Si | PVA | H₂O | PAA | / | 100 |
| Example 1 | | | | | | |
| Comparative | Si | PVA | NMP | PVDF | / | 100 |
| Example 2 | | | | | | |
| Comparative | Si | PVA | H₂O | PAA | CRF aerogel | 30 |
| Example 3 | | | | | | |
| Comparative | Si | PVA | H₂O | PAA | CRF aerogel | 100 |
| Example 4 | | | | | | |
| Comparative | / | PVA | H₂O | PAA | CRF aerogel | 100 |
| Example 5 | | | | | | |

Note:
¹The amount of the silicon-based material used in Examples 1-6, 9-17 and Comparative Examples 1-4 was 0.5 kg. The amount of the silicon-based material used in Examples 7 and 8 were 0.8 kg and 1 kg respectively.
²The porosity of the porous carbon aerogel in Examples 1-8, 10-17 and Comparative Examples 3-5 was 80%. The porosity of the porous carbon aerogel in Example 9 was 50%.

The solid contents of each of the second suspensions in Examples 1-17 and Comparative Examples 1-5 were measured immediately after preparation (T0), and the solid contents of the second suspensions were measured again after standing for 2 hours (T2) at room temperature. The results are shown in Table 2 below.

TABLE 2

| | Solid content (%) at T0 | | | |
|---|---|---|---|---|
| | Upper | | Solid content (%) at T2 | |
| | portion | Lower portion | Upper portion | Lower portion |
| Example 1 | 6.5 | 6.6 | 6.5 | 6.6 |
| Example 2 | 6.6 | 6.5 | 6.6 | 6.7 |
| Example 3 | 6.7 | 6.5 | 6.7 | 6.8 |
| Example 4 | 6.5 | 6.6 | 6.5 | 6.6 |
| Example 5 | 6.4 | 6.7 | 6.4 | 6.5 |
| Example 6 | 6.6 | 6.5 | 6.6 | 6.7 |
| Example 7 | 9.1 | 9.2 | 9.0 | 9.3 |
| Example 8 | 10.7 | 10.8 | 10.6 | 10.9 |
| Example 9 | 6.5 | 6.6 | 6.4 | 6.8 |
| Example 10 | 5.6 | 5.7 | 5.5 | 5.8 |
| Example 11 | 5.7 | 5.7 | 5.6 | 5.7 |
| Example 12 | 5.6 | 5.7 | 5.6 | 5.8 |
| Example 13 | 6.8 | 6.7 | 6.8 | 6.9 |
| Example 14 | 6.7 | 6.9 | 6.7 | 6.9 |
| Example 15 | 6.5 | 6.6 | 6.5 | 6.6 |
| Example 16 | 6.8 | 6.9 | 6.7 | 6.8 |
| Example 17 | 6.7 | 6.8 | 6.7 | 6.8 |
| Comparative | 6.3 | 6.8 | 6.1 | 6.7 |
| Example 1 | | | | |
| Comparative | 6.2 | 6.8 | 6.0 | 6.8 |
| Example 2 | | | | |
| Comparative | 6.4 | 6.7 | 6.1 | 6.8 |
| Example 3 | | | | |
| Comparative | 6.4 | 6.7 | 6.4 | 6.9 |
| Example 4 | | | | |
| Comparative | 2.0 | 2.1 | 1.9 | 2.2 |
| Example 5 | | | | |

These results show that particles in the second suspensions of Examples 1-17 and Comparative Examples 1-5 were uniformly dispersed when the solid contents of the second suspension were measured immediately after preparation (T0). After standing for 2 hours (T2) at room temperature, each of the second suspension of Examples 1-17 and Comparative Examples 1-5 remained homogenous and uniform. The suspending particles in the suspension would not settle out over time to form a hard agglomerate at the container bottom in stagnant storage.

The solid contents of each of the anode slurries in Examples 1-17 and Comparative Examples 1-5 were measured immediately after preparation (T0), and the solid contents of the anode slurries were measured again after standing for 2 hour (T2) at room temperature. The results are shown in Table 3 below.

TABLE 3

| | Solid content (%) at T0 | | | |
|---|---|---|---|---|
| | Upper | | Solid content (%) at T2 | |
| | portion | Lower portion | Upper portion | Lower portion |
| Example 1 | 50.0 | 50.1 | 50.0 | 50.1 |
| Example 2 | 49.8 | 49.7 | 49.8 | 49.9 |
| Example 3 | 49.4 | 49.2 | 49.4 | 49.5 |
| Example 4 | 50.3 | 50.4 | 50.3 | 50.4 |
| Example 5 | 50.1 | 50.2 | 50.1 | 50.2 |
| Example 6 | 49.5 | 49.4 | 49.5 | 49.6 |
| Example 7 | 50.7 | 50.8 | 50.6 | 50.9 |
| Example 8 | 51.2 | 51.3 | 51.1 | 51.4 |
| Example 9 | 49.8 | 50.2 | 49.6 | 50.3 |
| Example 10 | 49.7 | 49.6 | 49.6 | 49.7 |
| Example 11 | 49.5 | 49.8 | 49.6 | 49.7 |
| Example 12 | 49.7 | 49.8 | 49.6 | 49.8 |
| Example 13 | 49.7 | 49.5 | 49.7 | 49.8 |
| Example 14 | 49.9 | 50.1 | 49.9 | 50.0 |
| Example 15 | 50.0 | 50.1 | 50.0 | 50.1 |
| Example 16 | 50.3 | 50.4 | 50.3 | 50.4 |
| Example 17 | 49.5 | 49.6 | 49.4 | 49.6 |
| Comparative | 49.7 | 50.3 | 49.6 | 49.8 |
| Example 1 | | | | |
| Comparative | 49.9 | 50.1 | 49.8 | 50.0 |
| Example 2 | | | | |
| Comparative | 50.4 | 50.6 | 50.3 | 50.5 |
| Example 3 | | | | |
| Comparative | 49.7 | 50.3 | 49.6 | 49.8 |
| Example 4 | | | | |
| Comparative | 48.7 | 48.8 | 48.6 | 48.9 |
| Example 5 | | | | |

These results show that particles in each of the anode slurries of Examples 1-17 and Comparative Examples 1-5 were uniformly dispersed when the solid contents of the anode slurries were measured immediately after preparation (T0). After standing for 2 hours (T2) at room temperature, each slurry of Examples 1-17 and Comparative Examples 1-5 remained homogenous and uniform. The suspending particles in the slurry will not settle out over time to form a hard agglomerate on the bottom of the container in stagnant storage. If particles agglomerate and settle out of the anode slurry quickly to the bottom of the container, it can detrimentally affect the performance, such as cycle life, of a lithium-ion battery.

The discharge rate performance of the coin cells of Examples 1-17 and Comparative Examples 1-5 was evaluated. The coin cells were analyzed in a constant current mode using a multi-channel battery tester (BTS-4008-5V10 mA, obtained from Neware Electronics Co. Ltd., China). After an initial activation process at C/10 for 1 cycle, the cells were fully charged at a rate of C/10 and then discharged at a rate of C/10. This procedure was repeated by discharging the fully charged coin cells at various C-rates (1 C, 3 C and 5 C) to evaluate the discharging rate performance. The voltage range was between 0.005 V and 1.5 V. The results are shown in Table 4 below.

TABLE 4

| | Discharging rate | | |
|---|---|---|---|
| | performance (%) | | |
| | 1 C | 3 C | 5 C |
| Example 1 | 90.3 | 76.6 | 61.7 |
| Example 2 | 91.2 | 75.2 | 61.9 |
| Example 3 | 89.9 | 76.1 | 60.3 |
| Example 4 | 91.1 | 77.2 | 64.4 |
| Example 5 | 90.6 | 73.9 | 60.8 |
| Example 6 | 91.3 | 75.6 | 62.7 |
| Example 7 | 89.3 | 75.6 | 60.8 |
| Example 8 | 88.7 | 74.9 | 60.1 |
| Example 9 | 90.2 | 76.2 | 61.6 |
| Example 10 | 89.7 | 75.9 | 60.5 |
| Example 11 | 90.5 | 75.4 | 60.7 |
| Example 12 | 89.1 | 75.3 | 59.3 |
| Example 13 | 89.5 | 74.7 | 60.7 |
| Example 14 | 92.5 | 78.3 | 67.6 |
| Example 15 | 93.2 | 80.5 | 70.6 |
| Example 16 | 89.3 | 75.2 | 60.5 |
| Example 17 | 91.4 | 77.2 | 62.8 |
| Comparative Example 1 | 75.3 | 57.5 | 40.3 |
| Comparative Example 2 | 73.8 | 52.7 | 34.7 |
| Comparative Example 3 | 77.2 | 65.1 | 51.1 |
| Comparative Example 4 | 75.1 | 63.6 | 50.1 |
| Comparative Example 5 | 92.9 | 79.1 | 65.3 |

The coin cells of Examples 1-17 showed excellent rate performance at low and high discharge rates.

The coin cells of Examples 1-17 and Comparative Examples 1-5 were fully charged with a 0.1 C rate. The volume expansions of the cells at the end of the first and twentieth charging processes at 0.1 C were measured. The results are shown in Table 5 below.

TABLE 5

| | Thickness of | | | | |
|---|---|---|---|---|---|
| | electrode layer (μm) | | | Volume expansion (%) | |
| | | After 1^{st} | After 20^{th} | After 1^{st} | After 20^{th} |
| | Initial | full charge | full charge | full charge | full charge |
| Example 1 | 48 | 51 | 52 | 6.3 | 8.3 |
| Example 2 | 45 | 47 | 48 | 4.4 | 6.7 |
| Example 3 | 46 | 49 | 50 | 6.5 | 8.7 |
| Example 4 | 45 | 48 | 49 | 6.7 | 8.9 |
| Example 5 | 46 | 49 | 50 | 6.5 | 8.7 |
| Example 6 | 47 | 49 | 51 | 4.3 | 8.5 |
| Example 7 | 47 | 52 | 53 | 10.6 | 12.8 |
| Example 8 | 46 | 51 | 52 | 10.9 | 13.0 |
| Example 9 | 47 | 50 | 51 | 6.4 | 8.5 |
| Example 10 | 48 | 51 | 52 | 6.3 | 8.3 |
| Example 11 | 48 | 51 | 52 | 6.3 | 8.3 |
| Example 12 | 48 | 51 | 52 | 6.3 | 8.3 |
| Example 13 | 49 | 52 | 53 | 6.1 | 8.2 |
| Example 14 | 46 | 49 | 50 | 6.5 | 8.7 |
| Example 15 | 45 | 47 | 48 | 4.4 | 6.7 |
| Example 16 | 49 | 52 | 53 | 7.0 | 9.1 |
| Example 17 | 48 | 51 | 52 | 6.3 | 8.3 |
| Comparative | 46 | 77 | 78 | 67.4 | 69.6 |
| Example 1 | | | | | |
| Comparative | 47 | 83 | 85 | 77.0 | 81.2 |
| Example 2 | | | | | |
| Comparative | 47 | 72 | 74 | 51.9 | 56.1 |
| Example 3 | | | | | |
| Comparative | 48 | 71 | 73 | 47.6 | 51.8 |
| Example 4 | | | | | |
| Comparative | 48 | 49 | 49 | 2.1 | 2.1 |
| Example 5 | | | | | |

The experimentally measured volume expansions of the anode electrode layers of Examples 1-17 were much smaller than the values of Comparative Examples 1-4. The volume expansions of the anode electrode layers were mainly contributed by the silicon-based material because there was only a small change in the volume expansion in Comparative Example 5. This shows that the porous structure of the porous carbon aerogel is an effective way to accommodate the volume change of the silicon-based material.

The pouch cells of Examples 1-17 and Comparative Examples 1-5 were fully charged with a 0.1 C rate. The volume expansions of the cells at the end of the first and twentieth charge processes were measured and are shown in Table 6 below.

TABLE 6

| | Thickness of cell (mm) | | | Volume expansion (%) | |
|---|---|---|---|---|---|
| | | After 1^{st} | After 20^{th} | After 1^{st} | After 20^{th} |
| | Initial | full charge | full charge | full charge | full charge |
| Example 1 | 3.62 | 3.79 | 3.79 | 4.7 | 4.7 |
| Example 2 | 3.61 | 3.76 | 3.77 | 4.2 | 4.4 |
| Example 3 | 3.65 | 3.81 | 3.81 | 4.4 | 4.4 |
| Example 4 | 3.60 | 3.76 | 3.76 | 4.4 | 4.4 |
| Example 5 | 3.58 | 3.74 | 3.74 | 4.5 | 4.5 |
| Example 6 | 3.59 | 3.74 | 3.75 | 4.2 | 4.5 |
| Example 7 | 3.59 | 3.77 | 3.77 | 5.0 | 5.0 |
| Example 8 | 3.60 | 3.82 | 3.82 | 6.1 | 6.1 |
| Example 9 | 3.58 | 3.74 | 3.74 | 4.5 | 4.5 |
| Example 10 | 3.60 | 3.76 | 3.77 | 4.4 | 4.7 |
| Example 11 | 3.61 | 3.77 | 3.77 | 4.4 | 4.4 |
| Example 12 | 3.57 | 3.72 | 3.73 | 4.2 | 4.5 |
| Example 13 | 3.61 | 3.77 | 3.77 | 4.4 | 4.4 |
| Example 14 | 3.60 | 3.76 | 3.76 | 4.4 | 4.4 |
| Example 15 | 3.61 | 3.77 | 3.78 | 4.4 | 4.7 |
| Example 16 | 3.57 | 3.73 | 3.73 | 4.5 | 4.5 |
| Example 17 | 3.56 | 3.72 | 3.72 | 4.5 | 4.5 |
| Comparative | 3.61 | 4.61 | 4.62 | 27.7 | 28.0 |
| Example 1 | | | | | |
| Comparative | 3.59 | 4.65 | 4.65 | 29.5 | 29.5 |
| Example 2 | | | | | |
| Comparative | 3.57 | 4.38 | 4.38 | 22.7 | 22.7 |
| Example 3 | | | | | |
| Comparative | 3.60 | 4.31 | 4.31 | 19.7 | 19.7 |
| Example 4 | | | | | |
| Comparative | 3.60 | 3.66 | 3.66 | 1.7 | 1.7 |
| Example 5 | | | | | |

The experimentally measured volume expansions of the pouch cells of Examples 1-17 were much smaller than the values of Comparative Examples 1-4. The volume expansions of the pouch cells were mainly contributed by the silicon-based material because there was only a small change in the volume expansion in Comparative Example 5. This shows that the porous structure of the porous carbon aerogel is an effective way to accommodate the volume change of the silicon-based material. Since cells having the porous carbon aerogel underwent less volume change on charge and discharge than Comparative Examples 1-4, thereby improving the safety of battery and battery life over long term cycling.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

What is claimed is:

1. An anode slurry, comprising a silicon-based material, a porous carbon aerogel, a binder material, a carbon active material, and a solvent, wherein the porous carbon aerogel has an average pore size from about 80 nm to about 500 nm.

2. The anode slurry of claim 1, wherein the silicon-based material is selected from the group consisting of Si, SiOₓ, Si/C, SiOₓ/C, Si/M, and combinations thereof, wherein each x is independently from 0 to 2; M is selected from an alkali metal, an alkaline-earth metal, a transition metal, a rare earth metal, or a combination thereof, and is not Si.

3. The anode slurry of claim 1, wherein the silicon-based material has an average particle size from about 10 nm to about 500 nm.

4. The anode slurry of claim 1, wherein the silicon-based material has an average particle size from about 30 nm to about 200 nm.

5. The anode slurry of claim 1, wherein the porous carbon aerogel is selected from the group consisting of a carbonized resorcinol-formaldehyde aerogel, a carbonized phenol-formaldehyde aerogel, a carbonized melamine-resorcinol-formaldehyde aerogel, a carbonized phenol-melamine-formaldehyde aerogel, a carbonized 5-methylresorcinol-formaldehyde aerogel, a carbonized phloroglucinol-phenol-formaldehyde aerogel, a graphene aerogel, a carbon nanotube aerogel, a nitrogen-doped carbonized resorcinol-formaldehyde aerogel, a nitrogen-doped graphene aerogel, a nitrogen-doped carbon nanotube aerogel, a sulphur-doped carbonized resorcinol-formaldehyde aerogel, a sulphur-doped graphene aerogel, a sulphur-doped carbon nanotube aerogel, a nitrogen and sulphur co-doped carbonized resorcinol-formaldehyde aerogel, and combinations thereof.

6. The anode slurry of claim 1, wherein the porous carbon aerogel has an average particle size from about 100 nm to about 1 μm.

7. The anode slurry of claim 1, wherein the weight ratio of the silicon-based material to the porous carbon aerogel is from about 1:1 to about 10:1.

8. The anode slurry of claim 1, wherein the weight ratio of the silicon-based material to the porous carbon aerogel is from about 5:1 to about 10:1.

9. The anode slurry of claim 1, wherein the ratio of the pore size of the porous carbon aerogel to the particle size of the silicon-based material is from about 2:1 to about 20:1.

10. The anode slurry of claim 1, wherein the ratio of the pore size of the porous carbon aerogel to the particle size of the silicon-based material is from about 2:1 to about 10:1.

11. The anode slurry of claim 1, wherein the porosity of the porous carbon aerogel is from about 50% to about 90%.

12. The anode slurry of claim 1, wherein the specific surface area of the porous carbon aerogel is from about 100 m²/g to about 1,500 m²/g.

13. The anode slurry of claim 1, wherein the density of the porous carbon aerogel is from about 0.01 g/cm³ to about 0.9 g/cm³.

14. The anode slurry of claim 1, wherein the electrical conductivity of the porous carbon aerogel is from about 1 S/cm to about 30 S/cm.

15. The anode slurry of claim 1, wherein the silicon-based material is present in an amount from about 1% to about 10% by weight, based on the total weight of the anode slurry.

16. The anode slurry of claim 1, wherein the porous carbon aerogel is present in an amount from about 0.1% to about 10% by weight, based on the total weight of the anode slurry.

17. The anode slurry of claim 1, wherein the binder material is selected from the group consisting of styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose, hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid, polyacrylate, polymethacrylic acid, polymethacrylate, polyacrylamide, polyurethane, fluorinated polymer, chlorinated polymer, a salt of alginic acid, polyvinylidene fluoride, poly(vinylidene fluoride)-hexafluoropropene, and combinations thereof.

18. The anode slurry of claim 1, wherein the carbon active material is selected from the group consisting of hard carbon, soft carbon, artificial graphite, natural graphite, mesocarbon microbeads, and combinations thereof.

19. The anode slurry of claim 1, wherein the particle size of the carbon active material is from about 1 μm to about 20 μm.

20. The anode slurry of claim 1, wherein the solvent is selected from the group consisting of water, ethanol, isopropanol, methanol, acetone, n-propanol, t-butanol, N-methyl-2-pyrrolidone, and combinations thereof.
